(19) United States
(12) Patent Application Publication
(10) Pub. No.: US 2013/0211879 A1
(43) Pub. Date: Aug. 15, 2013

(54) USER-SELECTED ADVERTISEMENTS

(71) Applicant: Robert W. Holland, Austin, TX (US)

(72) Inventor: Robert W. Holland, Austin, TX (US)

(21) Appl. No.: 13/396,906

(22) Filed: Feb. 15, 2012

(51) Int. Cl. G06Q 30/02

(52) U.S. Cl. 705/7.32; 705/14.55; 705/14.47

(57) ABSTRACT

An end user earns points by selecting advertisement content and observing the advertisement content at a client at a first time period. The points are stored in memory until the end user desires to view entertainment content. A server streams entertainment content selected by the end user to the client at a second time period if the points stored for the end user are at least equal to a point cost of the entertainment content. For example, entertainment content that is normally streamed with advertisement content for presentation during commercial breaks is streamed at the second time period without advertisement content since the end user has already viewed advertisement content at the first time period.

### BACKGROUND OF THE INVENTION

1. Field of the Invention

The present invention relates in general to the field of presenting advertisement content to an end user, and more particularly to user-selected advertisements.

2. Description of the Related Art

Consumers have come to expect free entertainment content presented on television and through the Internet. In fact, entertainment content is typically funded by advertisements presented during “commercial” breaks that interrupt the presentation of entertainment content. A typical television station channel has more than ten minutes of advertisement content per broadcast hour. A television channel typically pays an entertainment content owner for the right to present entertainment content, such as a movie or sitcom, and then sells advertising time during commercial breaks to retailers, manufacturers, political candidates, or whoever wants to communicate a message to consumers. The revenue from sales of advertising time pays for the entertainment content, the costs of broadcasting and, hopefully for the television station, a profit for the television station.

The exchange of entertainment content for consumer exposure to advertisements is often actively resisted by consumers. Rather than watching Company A's commercial during halftime, Joe Sixpack will head to the fridge for Company B's beer and not return until the sound of his game returns. In some instances, consumers will elect not to watch entertainment content because of the advertisements interspersed in the entertainment content. For example, a mother may forbid her children from watching an educational children's show because she does not want her children to see advertisements during commercial breaks that market sugar-laced breakfast cereals to children. When consumers do not view advertisements, advertisers get little value for their payments to broadcasters.

The Internet has changed the conventional television model for presenting advertisements during commercial breaks of entertainment content. For example, Web pages often have a number of different advertisements intermixed with entertainment content for presentation at a computer display concurrent with the entertainment content. The advertisements include, for example, banner, text, interstitial, pop-up, opt-in mailing, HTML, rich media, and sponsorship advertisements. One example of a typical Web page that presents entertainment content to a consumer with advertisement funding is a broadcast television news channel website, which allows a consumer to select a news story for presentation as a movie on the consumer's computer display. Banner advertisements surround a video window that presents the news story as a movie. Before the news story movie plays in the video window, an advertisement is presented as a movie in the video window. The consumer is therefore bombarded by a variety of advertisements using a variety of techniques in exchange for the content owner's approval for the consumer to watch the news story movie entertainment content. In theory, at least some of the consumer's attention is trained on at least some of the advertising content so that the advertiser gains some marketing value from the purchase of advertising space on the Web page. In fact, however, the effectiveness of such advertising is often questioned so that advertisers pay correspondingly lower fees for the news channel when the advertiser purchases advertising space on the Web page.

Internet and other media entertainment content providers have attempted to improve the effectiveness of advertising content at communicating a message by employing a number of different techniques. GOOGLE recently offered to pay consumers to load spyware on the consumer's computer so that GOOGLE can track inputs made by the consumer and content viewed by the consumer. Exact knowledge of a consumer's behavior helps the Internet content provider predict how the consumer (and other consumers by using modeling techniques) will use and view content so that advertisements are more accurately targeted towards the interests of consumers. Ideally, a well-targeted advertisement presented to a consumer at a Web page leads the consumer to interact with the advertiser to provide the advertiser with a direct lead to a consumer who is more likely to make a purchase. Unfortunately for advertisers, consumers generally do not like being spied upon so that the types of personal information that most accurately helps target advertisements at consumers is rarely available for advertisers.

On-demand entertainment content providers, such as HULU and NETFLIX, stream entertainment content, such as television sitcom shows and movies, to a consumer's computer or television through an Internet interface so the user can watch the content on demand. Recently, HULU offered consumers a chance to select one of three different advertisements so that the consumer would see the selected advertisement during a commercial break in presentation of entertainment content. In theory, the consumer pays more attention to an advertisement selected by the consumer because the consumer has a greater interest in the content of the selected advertisement. However, the consumer has to take the time before the presentation of the entertainment content to select an advertisement and the advertisement interrupts the presentation of the entertainment content similar to the commercial break of the conventional television advertising model. Selection by a consumer from a limited number of options of advertisements does not guarantee that the consumer will actually watch the advertisement during the commercial break.

### SUMMARY OF THE INVENTION

Therefore a need has arisen for a system and method which efficiently targets advertisement content to consumers.

In accordance with the present invention, a system and method are provided which substantially reduce the disadvantages and problems associated with previous methods and systems for targeting advertisement content to consumers. A consumer selects and views advertisement content in a transaction that is temporally separate from viewing by the consumer of entertainment content that the consumer earned authorization to view with the consumer's viewing of the advertisement content.

More specifically, an end user consumer having a client computer interfaces with a server at a first time period to retrieve advertisement contents for presentation at the client computer. A verifier running on the client computer uses sensors of the client computer to verify that that end user consumer has viewed advertisement content with at least a minimal level of attention and communicates verification to the server. The server stores points in memory and associates the points with the end user consumer to reflect point values of advertisement content viewed by the end user consumer. At a second time period independent of the first time period, the end user consumer selects entertainment content to view with the points earned from viewing the advertisement content at the first time period. The points stored in memory associated with the end user consumer are reduced by a point cost of the entertainment content selected by the end user and the entertainment content is presented to the end user at the second time period, such as without advertisement content included in the entertainment content or with a lesser amount of advertisement content, such as a banner that reminds the end user consumer of the advertising entity that is sponsoring the end user consumer's view of the entertainment content.

The present invention provides a number of important technical advantages. One example of an important technical advantage is that a consumer's most valuable asset is respected: the consumer's time. A consumer chooses what advertisement content to watch and when to watch it. The consumer then has the freedom to use the value created by the consumer from watching the advertisement content when and how the consumer wants to use the value. Rather than presenting a nuisance by interrupting entertainment content, advertisement content presents a value to the consumer by allowing the consumer to self-target advertisements for gathering information of interest to the consumer. Accurate targeting of advertisements means a greater value to advertisers so that a consumer needs to watch fewer advertisements in exchange for the privilege of watching a given entertainment content. Respect for the consumer's time extends to the consumer's personal space and privacy. Consumer consent by agreement to watch advertisements in exchange for the privilege of watching entertainment content means that a local advertisement analyzer running on the consumer's computer can gather information for targeting advertisements without exposing the information external to the consumer's computer. Market forces drive efficiencies in the presentation of advertisement content that are not possible in a conventional television advertisement-funded entertainment content model because consumers are motivated to watch relevant advertisements, advertisers are motivated to create relevant advertisements that a consumer will select to watch and entertainment content is directly purchased by consumers with advertisement views separate from the presentation of the entertainment content based on a price determined by the entertainment content owner.

Another advantage to the present invention is that advertising entities have an opportunity to populate a database of video advertisements readily searchable by a consumer and having a message that is controllable by the advertising entities. When consumers search the Internet using a conventional search engine, the consumers often arrive at conflicting and confusing information. In some instances, advertising entities will pay a premium to have a website show up at the top of a search, however, negative and sometimes false information about the advertising entity might also show up. The questionable results of search engines also affect consumers who tend to question the validity and authenticity of information from websites. By limiting the consumers' search to a database of paid advertisements, the consumer has greater comfort in relying upon information gleaned from the advertisements. Moreover, the consumer will have greater comfort initiating a direct interaction with the advertiser through advertisement content from a trusted source.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for user-selected advertisements;

FIG. 2 depicts a flow diagram of a process for a user to select advertisements to earn points; and

FIG. 3 depicts a flow diagram of a process for a user to select entertainment content by exchanging points earned from observing advertisement content.

### DETAILED DESCRIPTION

Efficient self-targeted advertising temporally separates the value created by a consumer watching an advertisement from the value of entertainment content purchased by the consumer. The conventional advertisement-funded presentation of entertainment content is modified by allowing a consumer to earn points by selecting advertisement content the consumer wants to watch when the consumer wants to watch it, rather than attempting to force the consumer to watch advertisement contents interspersed during commercial breaks in entertainment content. The end user then gets to select and watch entertainment content uninterrupted by advertisement content by exchanging the points for a point cost of the entertainment content at a time convenient for the consumer to watch the entertainment content. In summary, the consumer looks at advertisements that both the consumer and an advertiser want the consumer to see when it is convenient for the consumer, and then the consumer gets to watch entertainment content that the consumer wants to watch that is indirectly paid for by the advertiser when the consumer wants to watch the entertainment content.

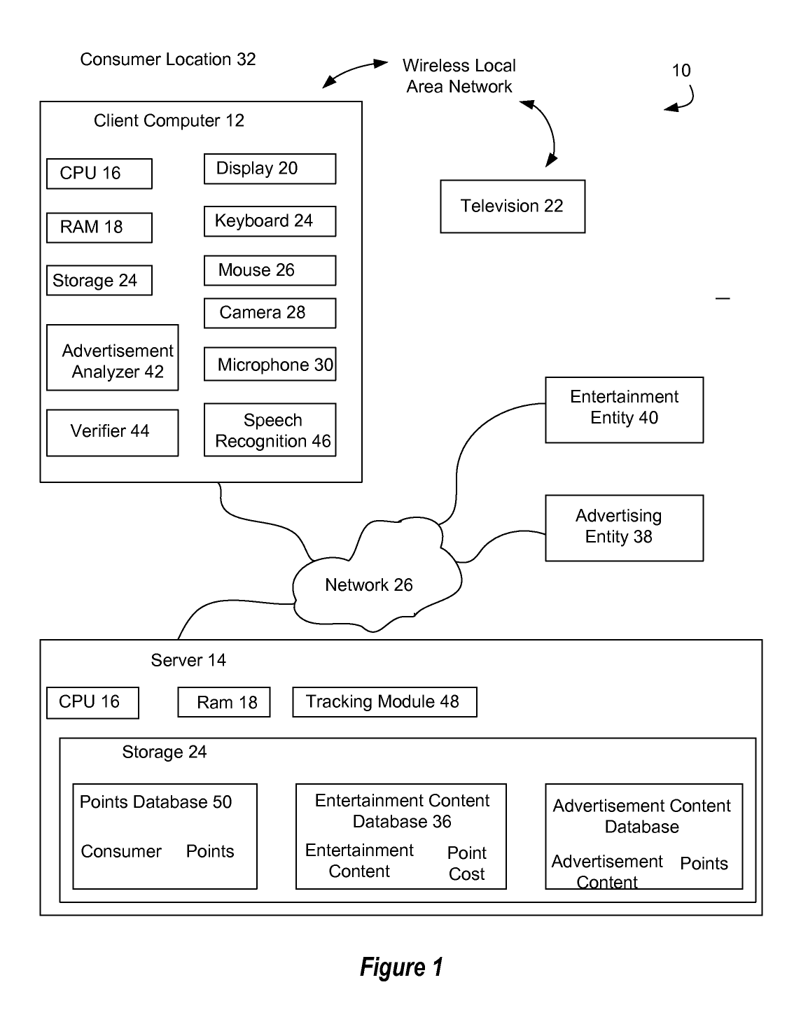

Referring now to FIG. 1, a block diagram depicts a system 10 for user-selected advertisements. Various embodiments of the system include computing devices, such as a client computer 12 and server computer 14, that process information with instructions executed on processors 16 and stored in memory 18. The instructions transform information into graphical images presented at a display 20, television 22 or other display device. The instructions store information in a variety of machine readable storage devices, such as DRAM, hard disk drives, solid state drives, optical drives or other types of storage devices. The instructions executed on processors 16 include instructions to communicate information over a network 26, such as the Internet, using a variety of communication protocols that stream information or copy files, such as TCP/IP, FTP, and other types of protocols. In the example embodiment depicted by FIG. 1, client computer 12 is a laptop, tablet or smartphone having a display 20 integrated in its housing. In alternative embodiments, other types of client computers may be used, including desktop computers, set top boxes used for communicating with a cable or satellite television provider, an optical drive player with an Internet interface or similar devices. Client computer 12 includes input devices to accept end user inputs, such as keyboard 24 and a mouse 26. Client computer 12 can also include other types of sensors, such as a web video camera 28 that captures images and a microphone 30 that captures audible sounds.

In the example embodiment depicted by FIG. 1, client computer 12 is located at a consumer location 32, such as a residence having a wireless local area network and interface with Internet 26. Client computer 12 interfaces through Internet 26 with server computer 14 to have access to plural advertisement contents in an advertisement content database 34 and to plural entertainment contents in an entertainment content database 36. In alternative embodiments, advertisement content may be distributed across plural network locations, such as at one or more advertisement entities 38 that desire to present advertisements to consumers. In alternative embodiments, entertainment content may be distributed across plural network locations, such as at one or more entertainment entities 40 that desire to sell entertainment content for presentation to consumers.

An end user consumer at consumer location 32 retrieves advertisement content from advertisement content database 34 through Internet 26 for presentation with client computer 12, such as at display 20 or television 22. To aid the selection of advertisement content from plural advertisement contents, an advertisement analyzer 42 executes on client computer 28 to analyze information input by the end user and determine interests of the end user. Unlike conventional spyware, advertisement analyzer 42 runs locally on client computer 12 without sending confidential or personal information to third parties. Advertisement analyzer 42 can run locally since the decision about what advertisements to present at client computer 12 is a decision made by the end user of client computer 12 instead of by a third party. Advertisement analyzer 42 presents suggestions to an end user of advertisements available from advertisement content database 34 that the end user may be interested in viewing. Advertisement analyzer 42 also accepts queries from the end user to help locate advertisement content of interest to the end user. For example, if an end user has performed a number of searches recently to locate information on fixing a car, advertisement analyzer 42 can preload advertisement contents, such as plural advertisement movies by plural car repair shops, and present the preloaded advertisements to the end user for the end user to select if the end user so desires. Alternatively, the end user can indicate a search for advertisements about new cars so that advertisement analyzer can prioritize car advertisement contents based upon information available at client computer 12 about the end user. If, for example, the end user listens to country music, then pickup trucks might get priority. If, on the other hand, the end user watches NASCAR races, muscle cars might get priority. In any event, the end user is empowered to select advertisements for viewing that are relevant to the end user with the advertisement analyzer available to help in the selection process. Similarly, advertising entities 38 can focus advertisement content on an interested consumer to convey compelling facts rather than focusing on attracting attention. In this manner, advertisement contents become more efficient at providing useful information for interested consumers so that the process of communicating advertisement content to consumers becomes more useful for both advertisers and consumers.

Once an end user consumer selects an advertisement content from the plural advertisement contents, the end user can view the selected advertisement content at display 20, television 22, or any appropriate presentation device, such as by communicating with display devices through a wireless local area network. The advertisement content can include any type of multimedia content, such as a conventional television commercial movie shown during a commercial break, a slide show, a document, a brochure or any content that communicates advertising information to promote a product, manufacturer, political cause, charity, etc. . . . The end user gets to select a time to view the selected advertisement content that is convenient for the end user. For example, a housewife might watch advertisements while doing housecleaning or cooking. In one embodiment, a consumer can earn higher points for viewing a given advertisement content based upon the time that the consumer selects to view the advertisement content. For example, an advertisement for food might offer more points for the consumer to earn if the consumer views the advertisement during time periods when the consumer is hungry or likely to be hungry, and an advertisement for beer might offer more points when consumers are more likely to consumer beer, such as during the time of day that football games are played. A consumer might watch advertisements while shopping for goods, either on line or at a retail location, in order to make a more informed purchase decision. The timing of the presentation of advertisement content is independent of the timing of the presentation of entertainment content that the end user is authorized to view in exchange for watching advertisement contents. Thus, a consumer endures less inconvenience for watching advertisement content yet gets the benefit for watching advertisement contents when convenient for the consumer by selecting when to watch entertainment content and then watching the entertainment content without interruptions from advertisement content commercial breaks.

A verifier 44 executing on client computer 12 verifies that the consumer has watched selected advertisement content with a predetermined attention level. If the consumer has watched the selected advertisement content with a predetermined attention level, then verifier 44 sends a message to server 14 to award points to the consumer end user for the presentation and observation of the selected advertisement content. In one embodiment, verifier 44 is limited in its communication with server 14 to provide only verification of presentation of selected advertisement content without providing the information used to establish verification. In this manner, verifier 44 can access detailed information available from sensors of client computer 12 without privacy concerns for the end user of client computer 12. For example, verifier 44 uses images captured by camera 28 and/or sounds captured by microphone 30 to analyze the attention of the end user consumer to the presentation of advertisement content. For instance, if the end user is not in the view of the camera or has a profile looking away from the presentation, verification is not provided. In one embodiment, verifier 44 stops the presentation of advertisement content when an end user is paying inadequate attention and issues a voice notification from a speaker of client computer 12 that the end user must watch the advertisement content to obtain an award of points. A similar function can aid the consumer when the consumer watches entertainment content by automatically pausing the entertainment content when the consumer is not viewing the content, such as when the user leaves the view of the camera or the microphone picks up the sound of a crying baby. Sensors can also verify the identity of the end user who is watching the advertisement content, such as by applying voice or image recognition.

Verifier 44 can also provide verification based upon one or more inputs made by an end user in response to the advertisement content. For example, an end user consumer looking for a new car might view a number of car advertisement contents, such as plural movie commercials by plural car manufacturers. When the consumer decides to pursue further information about one of the cars presented by the plural advertisement contents, the consumer interacts with the advertisement content of the car of interest to contact the advertising entity 38 associated with the advertisement content. Verifier 44 analyzes inputs made by the consumer at client computer 12 to determine that an inquiry for additional information to advertising entity 38 is authentic. Based upon the authenticity of the inquiry, verifier 44 provides verification of the advertisement contents to server 14. For example, if consumer end user activity indicates the viewing of new car advertisements and the consumer selects less than all of the new car advertisements to interact with, verification may be found because the searching activity of the consumer indicates that the consumer is narrowing down between several choices. In addition, a consumer end user may be awarded additional bonus points for establishing commercial interactions with an advertising entity, such as to purchase a product or inquire for additional information. In alternative embodiments, other types of inputs can provide verification of presentation of advertisement contents, such as inputs to an advertising entity survey, inputs to request additional information related to presentation of an advertisement content or analysis of inputs based upon historical inputs by the end user that indicates adequate attention paid by the end user consumer to presentation of advertisement contents. In one embodiment, inputs are made by voice commands from an end user that are analyzed by a speech recognizer 46 and transformed to text for communication to an advertising entity 38.

Verifier 44 communicates verification of presentation of advertisement content from client computer 12 to server 14 so that a tracking module 48 can track points awarded to consumers for views of advertisement content. Tracking module 48 inquires with advertisement content database 34 to obtain a point value associated with presentation of the verified advertisement content and stores the awarded points in a points database 50 by reference to the end user consumer of client computer 12. For example, watching a car movie advertisement might give an end user an award of 100 points while inquiring with the advertising entity of the car for a price quote might award a bonus of 25 points. Subsequent feedback from the advertising entity that the consumer purchased a car based upon the inquiry can result in additional bonus points. An advertising entity 38 determines points awarded for a given advertisement content with a higher points award likely to draw more views for the advertisement content at a greater expense to the advertising entity 38. An advertising entity can lower its advertising expense by generating advertising content of greater interest to consumers so that smaller point awards will still draw views. For example, consumers are more likely to view humorous advertisements prepared for the Super Bowl than ordinary advertisements made for everyday television commercials. Alternatively, an advertising entity can lower its advertising expense by narrowly targeting advertisement contents so that consumers will watch the most relevant content with a greater chance per view that a consumer will respond to an advertisement content. Thus, an economic incentive exists for an advertising entity to provide entertaining and relevant advertisement content that is less likely to waste a consumer's time.

Once an end user consumer builds sufficient points in point database 50, the end user consumer can exchange the points to obtain authorization to view entertainment content. The consumer selects an entertainment content, such as a movie or sitcom, from plural entertainment contents available from entertainment content database 36 for presentation at consumer location 32, such as with a selection through client computer 12 for presentation at display 20 or television 22. Tracking module 48 retrieves the number of points associated with the end user consumer from points database 50 and compares the points available for the consumer to exchange with a point cost associated with an entertainment content selected by the end user as stored in entertainment database 36. For example, a recently released movie might have a relatively high point cost, such as equivalent to viewing a half-dozen advertisement content movies, while a re-run television sitcom might have a relatively low point cost, such as equivalent to viewing a single advertisement content movie. If an end user consumer has points at least equal to the point cost of a selected entertainment content, tracking module 48 authorizes presentation of the selected entertainment content to the consumer, such as by streaming or other communication techniques, and reduces the consumers points in points database 50 by the point cost of the selected entertainment content. Entertainment content owners have control over the price of an entertainment content by setting the point cost of the entertainment content. Advertisement entities 38 pay the operator of tracking module 48 for advertising content verified as presented to an end user consumer based upon the points awarded to the end user consumer for watching the advertisement content. Entertainment entities 40 get paid by the operator of tracking module 48 based upon the views of an entertainment content and the point cost of the entertainment content. The operator of tracking module 48 makes a profit based upon the revenue raised from advertising entities 38 minus the cost paid to entertainment entities 40.

In one example embodiment, entertainment contents provided by server 14 is a movie streaming website that streams movies, such as Animal House, to a consumer location 32. In response to a selection by an end user of Animal House as entertainment content from plural entertainment contents of database 36, server 14 allows an end user to purchase a view of the movie with money, to have the movie streamed with commercial breaks that have advertisement contents or to apply points of the end user from database 50 so that the movie streams free of a money charge and free of advertisements in exchange for points of the end user. In one embodiment, a consumer without sufficient points to see an entertainment content in its entirety might select to see a portion of the entertainment content advertisement free for the value of points available to the consumer and a portion with advertisements included in commercial breaks. This allows the consumer to start viewing entertainment content immediately even if the consumer lacks points to view an entire entertainment content rather than having to pause to view additional advertisement contents.

In an alternative embodiment, entertainment content is a news website that streams news stories as movies to a consumer location through a website. The website includes banner advertisements disposed around a video window and movie advertisements inserted before each news story. The website has an advertisement point option specific to the website that allows a consumer to select and view advertisements at the website for points exchangeable only at that website. Consumers who select and view advertisement contents to earn points are then provided with access to the entertainment content of the news website, such as news stories, that is streamlined to be absent of advertisements, including the banner advertisements and the movie advertisements. The consumer creates greater value for the news website by viewing advertisements selected by the consumer so that the consumer has to view fewer advertisements to obtain access to the entertainment content than the consumer would have to view if advertisements were included in the entertainment content. The news website receives greater value with higher advertising revenue for fewer presentations of advertisement content and the consumer receives the news in less time than if the consumer had to watch an advertisement before each news story.

In another alternative embodiment, a mom selects advertisements to view to help her purchase clothes for her children. The mom earns points for selecting and viewing clothes advertisements and bonus points for interacting with an advertising entity, such as by purchasing clothes from interactions that start with an advertisement. When her children come home from school, the mom exchanges the points for access to educational entertainment content to show to the children without advertising content inserted in the entertainment content. In this way, the mom gets value from advertisements by shopping with relevant information presented by advertising entities and gets value from the entertainment content without her children being exposed to advertisements about sugar-laced cereals. Advertising entities get value by spending advertisement dollars on a consumer who will actually use advertisement information. The advertisement entities get to tailor a message for the consumer that would not ordinarily be available if the consumer used a search engine to shop. In one embodiment, the advertisement analyzer on the mom's client computer tracks that the mom shows the entertainment content to her children at predetermined times and provides the mom with a warning if the mom lacks sufficient points to watch the expected entertainment content so that the mom can view advertisement contents to build points before showtime.

In another alternative embodiment, a consumer with a smart phone enters a retail store and sees a QR code for the day's advertisement content of the retailer. The consumer takes a picture of the QR code, which brings up a browser to the retailer's website. The consumer watches a video of the day's advertisement content to earn points for viewing the advertisement and in the process, obtains valuable information about sales at the retailer for the day. The points allow the consumer to skip advertisements for his favorite sitcom that evening, which streams to his home television without commercial breaks having advertisement content or, alternatively, with a brief break or a banner from the retailer as the sponsor of the entertainment content. The retailer spends advertising dollars to sponsor the entertainment content; however, the retailer obtains value from the advertising dollars by directly communicating a message about sales to the consumer at an optimal time. Verification that the consumer viewed the advertisement content can be based upon the GPS location from the smart phone or a location provided by the QR code.

In another alternative embodiment, the consumer selects a live broadcast as entertainment content that has commercial breaks added as part of the broadcast. The consumer elects to spend points earned from watching advertisement contents to have the live broadcast sent without advertisement content in the commercial breaks. Instead of including advertisement content in commercial breaks, the advertisement content that would be sent to the consumer as part of the live broadcast is replaced with additional premium entertainment content. For example, rather than watching beer commercials at half time, the consumer gets switched to another game. Alternatively, instead of watching sugar-laced cereal commercials during breaks of a live child educational program, the consumer receives a game on ABC's, counting or other educational games targeted to the age group expected to watch the live show. As another example, instead of receiving commercials during a break in a news show, the consumer receives a summary of current news items displayed on the screen.

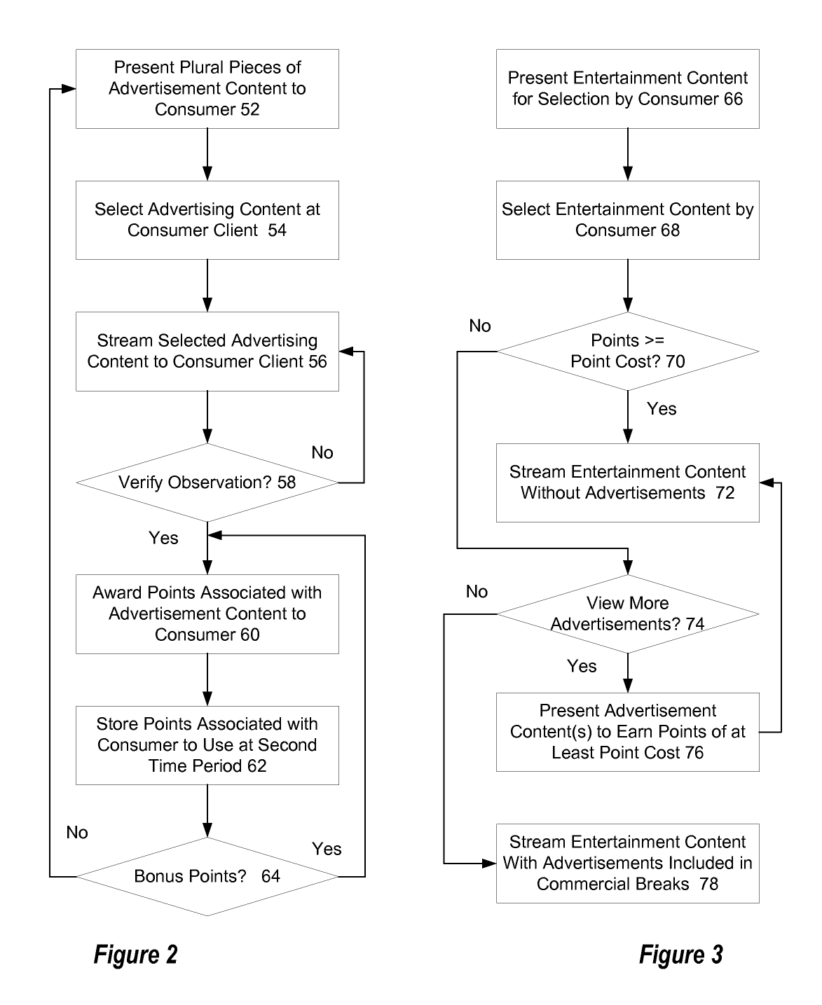

Referring now to FIG. 2, a flow diagram depicts a process for a user to select advertisements to earn points. The process begins at step 52 with the presentation of plural advertisement contents for selection by an end user of an advertisement content for observation by the end user. Each of the plural advertisement contents is a discrete advertisement for promotion of a good, manufacturer, cause, charity, politician, etc. . . . , and has an associated point value. In one embodiment, the point value for an advertisement can vary based on factors, such as the time of day, the region of the IP address of the consumer, a predicted authenticity of the consumer's desire to view the advertisement content, past behavior of the consumer, purchasing power of the consumer, the number of views by the end user of that advertisement etc. . . . . The point value for presentation of an advertisement content to a particular consumer may be presented to that consumer when the consumer considers the advertisement content for selection. At step 54, the end user selects an advertisement content from plural advertisement contents based on the end user's own interests and needs. In one embodiment, a rating system provides the end user with quality information about the advertisement, such as the number of views of the advertisement or end user rankings of the advertisement, to aid the end user in selection of a quality advertisement content. Good quality advertisements obtain more views by providing entertaining or particularly informative advertisement content, which tends to increase the overall quality of advertisements available for consumers to view.

At step 56, an end user consumer initiates streaming of a selected advertisement content to a display for viewing by the end user consumer. In alternative embodiments, the advertisement content can download to the end user's client computer to support watching while off-line, such as on an airplane trip. At step 58 a determination is made of whether or not to verify observation of the advertisement content by the end user. If not verified, the process returns to step 56 to provide the end user with another opportunity to view the advertisement content. If verified, the process continues to step 60 to award points to the end user for watching the advertisement content. For example, verification is made with sensors on the end user consumer's client computer, such as a camera that observes the end user, without sending the sensed information from the client computer so that the end user's privacy is protected. At step 62, the points awarded to the end user are stored so that the end user can exchange the points at a future time to obtain entertainment content free of advertisements. In one alternative embodiment, the points are stored in a secure location of the end user consumer's client computer system. At step 64, a determination is made of whether the end user has earned a bonus, such as by making a purchase or other interaction with the advertising entity that sponsored the advertisement content viewed by the end user. The process then returns to step 52 to present additional advertisement content. The selection of advertisement content and awarding of points for observing advertisement content are performed in a first time period that is independent of the selection and presentation of entertainment content by exchanging awarded points.

Referring now to FIG. 3, a flow diagram depicts a process for a user to select entertainment content by exchanging points earned from observing advertisement content. At step 66, plural entertainment contents are presented to the end user for selection of one or more entertainment contents. At step 68, the end user selects one or more of the entertainment contents for presentation. At step 70, a determination is made of whether the points awarded to the end user for presentation of advertisement content are sufficient to meet the point cost of the selected entertainment content. If yes, the process continues to step 70 to reduce the points of the end user by the point cost of the selected entertainment content and the entertainment content is communicated for presentation to the end user, such as by streaming, without advertisement content included in the entertainment content, or alternatively with less advertisement content included with the entertainment content as reflected by the point cost. If at step 70, the determination is that the end user has less points than the point cost, the process continues to step 74 to allow the end user to decide whether to view more advertisement content before viewing the entertainment content so that the entertainment content will be presented without interruptions by advertisement content. If yes, the process continues to step 76 to present additional advertisement content, such as by selection of the end user or by random selection, so that the end user earns enough points to meet the point cost. The process then continues to step 72 to present the entertainment content in exchange for points of the end user equal to the point cost of the entertainment content. If at step 74 the end user decides to view the entertainment content with commercial breaks having advertisement content instead of watching advertisement content separately, the process continues to step 78 to stream the entertainment content with advertisement content. The selection of entertainment content and exchange of points earned from observing advertisement content for the presentation of entertainment content are performed in a second time period that is independent of the selection and presentation of advertisement content so that an end user earns points and exchanges points in separate and independent transactions.

Although the present invention has been described in detail, it should be understood that various changes, substitutions and alterations can be made hereto without departing from the spirit and scope of the invention as defined by the appended claims.

What is claimed is:

1. A method for presenting entertainment content to a consumer, the method comprising:
selecting by the consumer an advertisement content from plural advertisement contents;
sending the selected advertisement content to a client of the consumer through a network;
storing points in a memory, the points associated with the consumer and representing a value for presentation of the selected advertisement content at the client;
selecting by the consumer an entertainment content from plural entertainment contents;
comparing a point cost of the selected entertainment content with the points stored in memory associated with the consumer to determine whether the consumer has points of at least the point cost; and
in response to determining that the consumer has points of at least the point cost, charging the point cost against the points to authorize presentation of the selected entertainment content for the consumer.

2. The method of claim 2 wherein in response to determining that the consumer has points of at least the point cost, charging the point cost against the points to authorize presentation of the selected entertainment content for the consumer further comprises authorizing presentation of the entertainment content without any advertisement content included in the entertainment content.

3. The method of claim 1 further comprising:
presenting the selected advertisement at the client; and
verifying observation of the advertisement content at the client before awarding the points to store in memory.

4. The method of claim 3 wherein verifying observation of the advertisement content at the client further comprises observing the consumer with a camera integrated in the client during the presenting the selected advertisement at the client.

5. The method of claim 3 wherein verifying observation of the advertisement content at the client further comprises:
accepting an input by the consumer at the client, the input having a response to the advertisement content; and
communicating the response to an advertising entity associated with the advertising content.

6. The method of claim 5 further comprising:
awarding additional points to the consumer for inputting the response to the advertisement content; and
storing the additional points in the memory.

7. The method of claim 5 wherein accepting an input by the consumer further comprises:
accepting the input as an oral statement by the consumer captured by a microphone of the client; and
analyzing the oral statement with speech recognition to provide the response as a text.

8. The method of claim 1 wherein the advertisement content comprises a movie by a car manufacturer describing a car.

9. The method of claim 1 wherein the entertainment content comprises Animal House.

10. A method for presenting entertainment content, the method comprising:
at a first time period, presenting advertising content at a client, the client associated with an end user;
storing points in a memory for the presenting advertising content, the points credited to the end user; and
at a second time period separate from the first time period, exchanging the points stored in the memory for authorization to present entertainment content.

11. The method of claim 10 further comprising:
streaming the entertainment content through a network to the client associated with the end user, the streaming in response to the exchanging; and
presenting the entertainment content at the client associated with the end user, the entertainment content free of advertisements.

12. The method of claim 10 further comprising:
streaming the entertainment content through a network to a television associated with the end user, the streaming in response to the exchanging; and
presenting the entertainment content at the television associated with the end user.

13. The method of claim 12 wherein the entertainment content includes commercial breaks having advertisement content and wherein presenting further comprises presenting the entertainment content without interruptions by removing the advertisement content.

14. The method of claim 10 further comprising verifying observation of the advertising content by the end user of the client during the presenting advertising content.

15. The method of claim 14 wherein verifying observation further comprises analyzing images of the end user of the client during the presenting advertising content, the images captured by a camera integrated in the client.

16. The method of claim 10 further comprising:
detecting an input by the end user of the client in response to the advertising content;
communicating the input from the client through a network to an advertising entity associated with the advertising content; and
in response to the communicating, storing additional points in the memory for the presenting advertising content.

17. A system for presenting entertainment content, the system comprising:
an entertainment content storage having plural entertainment contents;
an advertisement content storage having plural advertisement contents;
a client operable to select one or more advertisement contents from the advertisement storage for presentation to an end user at a first time period, the presentation of each advertisement content associated with one or more predetermined points, the client further operable to select one or more entertainment contents for presentation at the client at a second time period, each of the selected one or more entertainment contents having a point cost; and
a server operable to authorize communication of the selected one or more entertainment contents from the entertainment content storage to the client at the second time period in response to the selection of the one or more entertainment contents at the client if the points of the client from presentation of the advertisement content equals at least the point cost of the selected one or more entertainment contents.

18. The system of claim 17 further comprising an advertisement analyzer executing on the client and operable to monitor inputs made at the client to predict advertisement content selected by the end user.

19. The system of claim 17 further comprising a verifier executing on the client and operable to verify observation of the advertisement content by the end user.

20. The system of claim 19 further comprising a camera integrated in the client and interfaced with the verifier, the verifier verifying observation of the advertisement content by analyzing images of the end user captured by the camera.
